(19) United States
(12) Patent Application Publication
(10) Pub. No.: US 2023/0303315 A1
(43) Pub. Date: Sep. 28, 2023

(54) SMART POD AND MOBILITY FOR TRANSPORTING THE SAME

(71) Applicants: Hyundai Motor Company, Seoul (KR); Kia Corporation, Seoul (KR)

(72) Inventors: Jae Hoon Chung, Seoul (KR); Jong Min Oh, Hwaseong-si (KR); Ji A Lee, Seoul (KR); Ki Seok Sung, Seongnam-si (KR); Jong Kyu Choi, Yongin-si (KR); Young Jun Byun, Seoul (KR); Kye Yoon Kim, Gunpo-si (KR); Ji Min Han, Anyang-si (KR)

(21) Appl. No.: 17/885,378

(22) Filed: Aug. 10, 2022

(30) Foreign Application Priority Data
Mar. 28, 2022 (KR) 1020220037901

(51) Int. Cl. B65D 88/14; B60P 1/64; B65D 88/02; B65D 90/00

(52) U.S. Cl. CPC B65D 88/14; B60P 1/6418; B65D 88/022; B65D 90/008; F25D 11/003

(57) ABSTRACT

A smart pod is used for safe and convenient loading and unloading of cargo as well as fast and efficient transport thereof, and a mobility system transports the smart pod. The smart pod includes an upper surface, a lower surface, and a pair of first sidewalls connecting the upper surface and the lower surface to each other. The first sidewalls have a hexagonal shape, and a fastening protrusion is installed on the upper surface and configured to retract from the upper surface.

### CROSS-REFERENCE TO RELATED APPLICATION(S)

This application claims, under 35 U.S.C. § 119(a), the benefit of Korean Patent Application No. 10-2022-0037901, filed on Mar. 28, 2022, in the Korean Intellectual Property Office, the disclosures of which are incorporated herein by reference in their entirety.

### TECHNICAL FIELD

The present disclosure relates to a smart pod for transporting cargo and a mobility for transporting the smart pod.

### BACKGROUND

Various methods may be used to transport cargo by using an aircraft. For example, a cargo unmanned aerial system (CUAS) to carry a medium-sized cargo may include a drone for transporting a small cargo.

In some cases, a pod may be used to load and unload the cargo in any shape into the aircraft to thereby transport the cargo by using such an aircraft.

In some cases, the aircraft may lack space to load cargo, as compared to another transportation system. In some cases, a center of gravity of the entire aircraft may be moved by a center of gravity of the cargo, and it is thus essential for safe flight to align these centers of gravity with each other.

Accordingly, there has also been an increasing need for a pod enabling efficient use of the space in the aircraft and stable distribution of a weight of the cargo loaded in the space in the aircraft.

### SUMMARY

The present disclosure describes a smart pod for safe and convenient loading and unloading of cargo as well as fast and efficient transport thereof, and a mobility for transporting the smart pod.

The present disclosure further describes a smart pod using a minimum load space and stably supporting a weight of cargo during its loading, and a mobility for transporting the smart pod.

According to one aspect of the subject matter described in this application, a smart pod for transporting cargo includes an upper surface, a lower surface, and a pair of first sidewalls that connect the upper surface and the lower surface to each other, where each of the pair of first sidewalls has a hexagonal shape. The smart pod further includes a fastening protrusion disposed at the upper surface and configured to retract from the upper surface.

Implementations according to this aspect can include one or more of the following features. For example, the smart pod can further include a pair of second sidewalls that connect the pair of first sidewalls to each other, where each of the pair of second sidewalls includes an upper inclined surface connected to the upper surface and inclined with respect to the upper surface, and a lower inclined surface connected to the lower surface and inclined with respect to the lower surface.

In some examples, at least one of the pair of first sidewalls can define an opening configured to receive and withdraw the cargo therethrough. The smart pod can further include a door disposed at the at least one of the pair of first sidewalls and configured to open and close the opening. In some examples, the door can include a touchscreen configured to receive input of cargo information related to the cargo, where the touchscreen is configured to display the cargo information or to cause the cargo information to be transmitted to an external server.

In some implementations, the lower surface can define a concave groove that is recessed from an outside of the smart pod to an inside of the smart pod and has a shape corresponding to the fastening protrusion, where the concave groove is configured to receive and couple to a fastening protrusion of another smart pod. In some examples, the smart pod can further include a terminal that is disposed in the concave groove and electrically connected to a battery.

In some implementations, the smart pod can include at least one of a solar power module, a global positioning system (GPS) module, a communications module, or a temperature control module.

In some implementations, the upper surface can define a groove, and the fastening protrusion can include a fastening member configured to retract into the groove of the upper surface, and a driver disposed at the upper surface and configured to reciprocate the fastening member relative to the upper surface. For example, the fastening member can be made of a conductive material and electrically connected to a battery.

In some examples, the fastening member can define a rack gear on at least one surface thereof. The driver can include a motor that is configured to receive power from the battery and includes a rotation shaft, and a pinion gear engaged with the rack gear and configured to rotate the rack gear based on rotation of the rotation shaft.

In some implementations, the smart pod can further include a position detection sensor configured to detect a position of the fastening protrusion relative to a coupling object, where the coupling object includes (i) a concave groove configured to couple to the fastening protrusion and (ii) a reaction member that is disposed in the concave groove and configured to be detected by the position detection sensor.

In some examples, the smart pod can be configured to be moved by a transport apparatus that is configured to be controlled by a transport controller. The smart pod can further include a pod controller that is connected to the transport controller and configured to communicate with the transport controller to thereby restrict the transport apparatus from moving based on the position detection sensor detecting the reaction member.

In some implementations, the smart pod can be one of a plurality of smart pods that are configured to be stacked on one another, where the plurality of smart pods include a first smart pod having a first size and a second smart pod having a second size greater than the first size.

According to another aspect, a mobility apparatus includes a cargo hold that is configured to accommodate the smart pod described above, where the cargo hold has a surface configured to be opened to receive or release the smart pod. The cargo hold includes a bottom plate that defines a cut groove configured to receive and release the smart pod therethrough.

Implementations according to this aspect can include one or more of the following features. For example, the mobility apparatus can further include a transport apparatus configured to move the smart pod, where a width of the cut groove is greater than a width of the transport apparatus such that the cut groove allows the transport apparatus to be moved in the cut groove and to be raised from the cut groove based on the smart pod being moved by the transport apparatus.

In some implementations, the bottom plate can have an open end, and the cut groove can be defined at the open end of the bottom plate. In some implementations, an overall cross-sectional shape of the cargo hold can be a hexagonal shape corresponding to a cross-sectional shape of the smart pod.

In some implementations, the mobility apparatus can further include a guide configured to control approach and alignment between the transport apparatus and the smart pod. For example, the guide can include a light source configured to define a guide line.

In some implementations, the smart pod can include a position detection sensor configured to detect a position of the cargo hold, and the cargo hold can include a concave groove at a ceiling surface thereof, and a reaction member disposed in the concave groove and configured to be detected by the position detection sensor.

In some implementations, the mobility apparatus can include a chuck configured to grip the fastening protrusion of the smart pod that is inserted into the concave groove, and a control system configured to control operation of the chuck.

### BRIEF DESCRIPTION OF DRAWINGS

The above and other aspects, features and advantages of the present disclosure will be more clearly understood from the following detailed description taken in conjunction with the accompanying drawings.

FIG. 1 is a perspective view showing an example of a smart pod from above.

FIG. 2 is a perspective view of the smart pod from below.

FIG. 3 is a perspective view showing an example of a plurality of smart pods that are stacked on each other.

FIG. 4 is a configuration diagram schematically illustrating an example of control compenents of the smart pod.

FIG. 5 is an enlarged cross-sectional view showing an example of a fastening protrusion illustrated in FIG. 1.

FIGS. 6A through 6C are views each showing examples of the smart pod.

FIG. 7 is a cross-sectional view showing an example of the smart pod.

FIG. 8 is a view for explaining an example of a method for loading the smart pod to a mobility apparatus.

FIG. 9 is an enlarged view specifically showing an example of a portion of the loading method illustrated in FIG. 8.

FIG. 10 is a view for explaining an example of the method of loading the smart pod to a mobility apparatus.

### DETAILED DESCRIPTION

Hereinafter, exemplary implementations in the present disclosure will now be described in detail with reference to the accompanying drawings. It is to be noted that in giving reference numerals to components of the accompanying drawings, the same components are denoted by the same reference numerals even though the components are illustrated in different drawings.

For convenience of explanation, this specification describes that the present disclosure is applied to air mobility system or apparatus including a cargo hold as an example, and the present disclosure is not necessarily limited thereto. For example, the present disclosure can be applied not only to an air mobility system but also to a land mobility system.

Terms such as ‘first’ and ‘second’, can be used to describe various components. However, the order, size, position and importance of these components are not limited by the terms such as ‘first’ and ‘second’. These terms are used only to distinguish one component from another component.

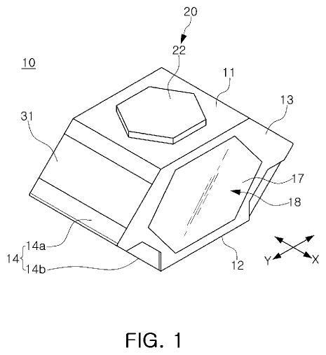

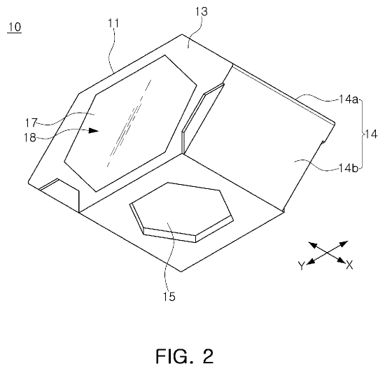

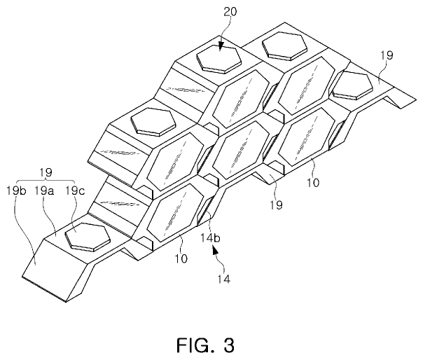

FIG. 1 is a perspective view showing an example of a smart pod from above. FIG. 2 is a perspective view showing the smart pod from below. FIG. 3 is a perspective view showing an example of a plurality of smart pods that are stacked on each other.

In some examples, a smart pod can include a container configured to accommodate cargo. The smart pod can include at least one of an electric circuit, a sensor, a signal transmitter, or the like to communicate with transporting apparatuses, systems, or other smart pods. In some examples, the smart pod can include a moving mechanism configured to interact with the transporting apparatuses, systems, or other smart pods.

In some implementations, a smart pod 10 can include an upper surface 11, a lower surface 12, a pair of first sidewalls 13 and a fastening protrusion 20. In some examples, the pair of first sidewalls can respectively have a hexagonal shape. Accordingly, the smart pod can have a hexagonal cross section, and have a shape of a hexagonal pole lying on its side.

In some implementations, the smart pod 10 can include a pair of second sidewalls 14 connecting the upper surface 11, the lower surface 12 and the pair of first sidewalls 13 to one another. The pair of second sidewalls can respectively include an upper inclined surface and a lower inclined surface.

Except for each first sidewall 13, the upper surface 11, the lower surface 12 and the upper inclined surface 14a and the lower inclined surface 14b which are included in the pair of second sidewalls 14 can respectively have a rectangular shape.

For example, an axis connecting the first sidewall 13 of the smart pod 10 can be referred to as a length-direction axial line X, and an axis connecting the second sidewall 14 and parallel to the upper surface 11 and the lower surface 12 while being extended at a right angle to the length-direction axial line can be referred to as a width-direction axial line Y.

The smart pod 10 can be made of a solid material such as metal or plastic, for example. In some examples, the upper surface 11, a lower surface 12, a first side wall 13 and a second sidewall 14 of the smart pod can be integrally molded with each other.

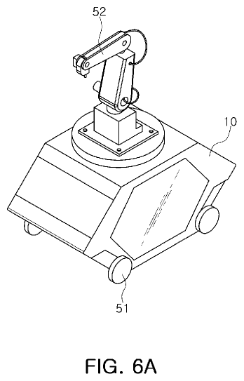

At least one of the pair of first sidewalls 13 can include an opening 16 (see FIG. 6C) and a door 17 each for receiving and withdrawing cargo in and from the smart pod 10.

The opening 16 can have the hexagonal shape corresponding to the shape of the first sidewall 13, and the shape of the opening is not necessarily limited thereto.

For example, one side of the door 17 and the first sidewall 13 can be connected via a hinge, and the door can be opened and closed by being pivoted about the hinge.

The upper surface 11, the lower surface 12 and the side walls 13 and 14 can respectively have a predetermined thickness to support a load of the cargo received in the smart pod 10 and that of the smart pod itself.

In some implementations, the fastening protrusion 20 can be installed to be retractable as illustrated in FIG. 1 and positioned on the upper surface 11 of the smart pod 10. The fastening protrusion 20 is described in more detail below.

For example, a concave groove 15 can be recessed from the outside to the inside, as illustrated in FIG. 2, and be positioned in the lower surface 12 of the smart pod 10. The fastening protrusion 20 of another smart pod can have a shape corresponding to a shape of the concave groove and can be inserted into the concave groove, and the smart pods can thus be stably stacked on each other.

In some implementations, where the plurality of smart pods 10 are provided, as illustrated in FIG. 3, the plurality of smart pods can be stacked on each other. For instance, rectangular surfaces of the smart pods adjacent to each other, that is, the upper surface 11, the lower surface 12, the upper inclined surface 14a and the lower inclined surface 14b can be in surface contact with each other. Accordingly, there is no space between the surfaces in contact with each other and a load applied to the surface can be distributed.

In some examples, the fastening protrusion 20 can be positioned on the upper surface of the lower smart pod 10 and protrude to be inserted into the concave groove 15 in the lower surface of the upper smart pod 10, thereby more stably stacking the smart pods on each other. In addition, the hexagonal shape of the smart pods can further facilitate the stable stacking of a smart pod in a space defined between two or more smart pods.

The smart pod can further include a support member 19 allowing the smart pods positioned on a lowest layer to maintain a predetermined distance from each other and other smart pods to be stacked on each other alternately by a half a height of the smart pod between the smart pods positioned on the lowest layer when the plurality of smart pods 10 are stacked on each other.

In some implementations, the support member 19 can include a horizontal support surface 19a, a pair of inclined surfaces 19b connected to both sides of the support surface and extended downwardly, and a protrusion 19c positioned on an upper surface of the support surface. The protrusion can protrude upward from the support surface, have the shape corresponding to the shape of the concave groove 15 positioned in the lower surface of the smart pod 10, and be inserted into the concave groove 15.

The size and shape of the support surface 19a can be the same as the size and shape of the lower surface 12 of the smart pod 10. In addition, an inclination of the inclined surface 19b to the ground can be the same as an inclination of the lower inclined surface 14b of the second sidewall 14 of the smart pod to its bottom or the ground. A distance between lower ends of the two inclined surfaces can be the same as a maximum length of the smart pod in the width-direction axial line Y.

The support member 19 configured in this manner can be in surface contact with the lower surface 12 and lower inclined surface 14b of the smart pods 10 adjacent to each other. Accordingly, there is no space between the surfaces in contact with each other and the load applied to the surface can be distributed.

Therefore, the present disclosure can provide the smart pod 10 using a minimum load space and stably supporting a weight of cargo during its loading.

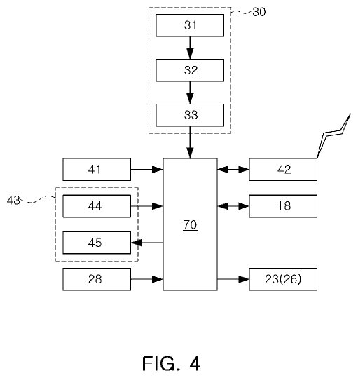

FIG. 4 is a configuration diagram schematically illustrating a control relationship of the smart pod.

The smart pod 10 can selectively include at least one of a solar power module 30, a global positioning system (GPS) module 41, a communications module 42 and a temperature control module 43.

The solar power module 30 can include a solar cell panel 31, a converter 32 and a battery 33.

The solar cell panel 31 can include a small cell made of silicon or the like. Each cell can be an element having a principle in which sunlight is incident on a surface to cause a separation of charges, and these charges are extracted to the outside, thereby producing electrical energy.

The solar cell panel 31 can be mounted on the upper inclined surface 14a of the second sidewall 14 as illustrated in FIG. 1.

The converter 32 can convert a current generated by and flowing in the solar cell panel 31.

The battery 33 can store the electrical energy generated by the solar cell panel 31, and provide power to one or more components of the smart pod 10.

The GPS module 41 can detect a current position of the smart pod 10 in real time and transmit information on the position to a controller 40 (“pod controller”) described below. The GPS module can be connected to, for example, the controller through a serial interface, and transmit the position information to the controller periodically, for example, every minute. In some examples, the controller 40 can include an electric circuit, a processor, a non-transitory memory, a computer, or the like.

The communications module 42 can receive the position information of the smart pod 10 from the controller 40 and transmit the received information to an external management server or a control system in real time or periodically. The communications module can be connected to, for example, the controller through the serial interface, and transmit the position information to the management server or the control system through an internet.

The temperature control module 43 can include a temperature sensor 44 and a temperature controller 45.

The temperature sensor 44 can detect a temperature in the smart pod 10 in real time and transmit temperature information to the controller 40. The controller can control the communications module 42 to transmit the temperature information of the smart pod to the external management server in real time or periodically.

The temperature controller 45 can include a heater and/or a cooler and a blower. An electric heater generating heat through a heating element to which the electrical energy is applied can be employed as the heater. The cooler can exchange heat with air in the smart pod by using a gaseous or liquid refrigerant.

The blower can be used to circulate air in the smart pod 10 back into the smart pod after being heated by the heater or cooled by the cooler.

The configuration of the temperature controller 45 is not limited to the above-described example, and can include, for example, a thermoelectric element using Peltier effect, a heat sink, a blower or the like to selectively apply cooling or warming of heat depending on a situation.

When the temperature in the smart pod 10 measured by the temperature sensor 44 is lower than a preset reference temperature, the controller 40 can control an operation of the heater or allow a backward current to be applied to the thermoelectric element to provide warm air in the smart pod.

Alternatively, when the temperature in the smart pod 10 measured by the temperature sensor 44 is higher than the preset reference temperature, the controller 40 can control an operation of the cooler or allow a forward current to be applied to the thermoelectric element to provide cool air in the smart pod.

Due to the temperature control module 43 configured in this manner, the smart pod 10 can allow a temperature-sensitive cargo such as food, food ingredients, medicines, blood or human organs to be transported while maintaining the cargo at a predetermined temperature.

The door 17 of the smart pod can selectively include a touchscreen 18. For example, at least a partially transparent display (e.g., transparent organic light emitting diode (OLED)) and a transparent electrode can be applied to the touchscreen.

The touchscreen 18 can be electrically connected to the controller 40. In this case, a user can operate the touchscreen to input information on the cargo to the controller, display the information on the display or transmit the information to the external management server. In addition, the user can also perform an authentication process through the touchscreen in relation to an approach right to the cargo.

Accordingly, the smart pod 10 can be used in connection with not only a mobility system or apparatus 90 transporting the cargo, but also a smart building, a smart warehouse or the like made by convergence of intelligent networking technology and automation technology.

The controller 40 can store information input through the touchscreen 18 based on a user request, and provide desired information through the touchscreen.

The battery 33 can supply power to the GPS module 41, the communications module 42, the temperature control module 43, the touchscreen 18, or the like. In addition, the battery can be electrically connected to the fastening protrusion 20 to provide power to a separate device or to be charged by an external power source.

In addition, a terminal unit electrically connected to the battery 33 can be positioned in the concave groove 15 of the lower surface 12. For example, when the fastening protrusion 20 of another smart pod 10 is inserted into the concave groove to stack the smart pods on each other, the fastening protrusion can be connected to the terminal unit of the concave groove. In this manner, the smart pod on the fastening protrusion side can receive power from the battery of the smart pod on the concave groove side, thereby charging power.

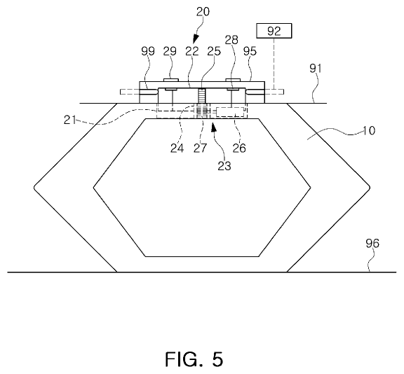

FIG. 5 is an enlarged cross-sectional view showing the fastening protrusion illustrated in FIG. 1.

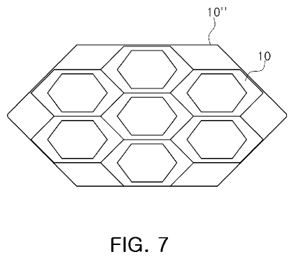

According to the present disclosure, the fastening protrusion 20 can be positioned on the upper surface 11 of the smart pod 10 to be retractable, and coupled to cargo hold 91 of the mobility apparatus 90 (see FIG. 8) accommodating and transporting the smart pod or to another smart pod, thereby fixing and holding the position and posture of the smart pod.

The fastening protrusion 20 can include a groove 21 positioned in the upper surface 11, a fastening member 22 which can be received in the groove, and a driver 23 installed on the upper surface to reciprocate the fastening member.

The groove 21 can have a polygonal cross section such as a hexagon for example, and is not limited thereto. A through hole 24 through which the fastening member 22 and the driver 23 are connected to each other can be positioned in at least one sidewall or bottom surface of the groove.

In some implementations, the fastening member 22 can have the polygonal cross section such as the hexagon for example, and is not necessarily limited thereto. For example, the fastening member 22 can include a plate having a hexagonal shape. In some examples, the fastening member 22 can have a hexagonal prism shape or a bar shape that extends in a vertical direction with respect to the upper surface 11 of the smart pod.

In some examples, the fastening member 22 can be made of a conductive material such as metal including copper, aluminum or steel to be used to fix the position of the smart pod 10 as well as to transmit electricity.

For example, the fastening member 22 can be electrically connected to the battery 33 via a wire or the like. Accordingly, the fastening member can be used as a conductor applying power to an external device from the battery. In some cases, the fastening member can be used as a conductor that can charge the battery from the external power source.

A rack and pinion mechanism can be employed as the driver 23. For example, a rack gear 25 can be formed on at least one surface of the fastening member 22, and a pinion gear 27 connected to a rotation shaft of a motor 26 can be rotated in engagement with the rack gear, thereby reciprocating the fastening member in and out of the groove 21.

In this case, the rack and pinion mechanism can be connected to each other through the through hole 24 positioned in one sidewall of the groove 21. In addition, the rack and the pinion mechanism can be provided in pairs to implement a stable operation of the fastening member 22.

In some examples, the rack gear 25 can be defined at an inner surface of the fastening member 22, and the motor 26 and the pinion gear 27 can be accommodated in an inside space of the fastening member 22, where the pinion gear 27 contacts and engages with the rack gear 25.

In addition, the motor 26 can be powered from the battery 33 under a control of the controller 40, and can be rotated forward and backward based on the application of power. The fastening member 22 can reciprocate, that is, can be raised or lowered by a drive force generated by an operation of the motor, and the fastening member can protrude from the upper surface 11 or be immersed into the groove 21.

However, the driver 23 is not limited to the above example, and can employ, for example, a hydraulic cylinder such as a pneumatic cylinder, an electric actuator such as a solenoid actuator or the like, having an operation rod.

The fastening member 22 of the fastening protrusion 20 can be inserted into a concave groove 95 positioned in the cargo hold 91 of the mobility apparatus 90 or the concave groove 15 positioned in the lower surface 12 of another smart pod 10 and can be coupled to the same.

For this coupling, the fastening protrusion 20 can further include at least one position detection sensor 28 detecting a position of the fastening member 22 with respect to the concave groove. The position detection sensor aligns the fastening member with the concave groove of a coupling object so that the fastening member can be smoothly inserted into the concave groove.

The position detection sensor 28 can be a sensor such as an image sensor, an optical sensor, a magnetic sensor or the like for aligning the positions of the concave groove of the coupling object and the fastening member 22 with each other.

For sensing of the position detection sensor, a reaction member 29 can be attached to or mounted in the concave groove of the coupling object. The reaction member can be any of various members based on the shape and specification of the position detection sensor.

For example, when the position detection sensor 28 is the image sensor, a marker having a predetermined shape and color can be used as the reaction member 29. When the position detection sensor is the optical sensor, a reflector reflecting light or a corresponding sensor emitting or receiving light can be used as the reaction member. In addition, when the position detection sensor is the magnetic sensor, a permanent magnet or a ferromagnetic material can be used as the reaction member.

In some implementations, a transport apparatus can be used to load a smart pod to and unload the smart pod from a mobility apparatuses such as air crafts, automobiles, motor vehicles, trains, or other types of vehicles. For example, the transport apparatus can include a transport robot.

For example, when the smart pod 10 is loaded in the mobility apparatus 90, the smart pod 10 can be moved by a transport robot 80 until the position detection sensor 28 detects the corresponding reaction member 29 of the mobility.

The position detection sensor 28 can transmit a detection signal to the controller 40, and the controller 40 can transmit the detection signal to a controller (“transport controller”) of the transport robot 80 by using the communications module 42, thereby sharing the position information of the smart pod 10 with respect to the concave groove 95 of the mobility apparatus 90.

Accordingly, the controller 40 can control a movement of the transport robot 80 together with the controller of the transport robot, thereby allowing the fastening protrusion 20 of the smart pod 10 and the concave groove 95 of the mobility apparatus 90 to be aligned with each other.

In addition, the position detection sensor 28 can transmit the detection signal to a controller 40, and the controller can transmit the detection signal to a control system 92 of the mobility apparatus 90 by using the communications module 42, thereby sharing the position information of the smart pod 10 with respect to the concave groove 95 of the mobility.

The control system 92 of the mobility apparatus 90 can be separately mounted on the mobility, or can be used for both purposes by being integrated into another control system or a higher-level main control system positioned in the mobility.

Accordingly, after allowing the fastening protrusion 20 of the smart pod 10 and the concave groove 95 of the mobility apparatus 90 are aligned with each other, the controller 40 can control an operation of a chuck 99 positioned in the concave groove of the mobility together with the control system 92 of the mobility, thereby allowing the fastening protrusion of the smart pod to be fixed in the concave groove of the mobility by the chuck 99.

FIGS. 6A through 6C are views each showing a modified example of the smart pod.

The smart pod 10 illustrated in FIG. 6A can include a plurality of wheels 51 as a moving means improving convenience of movement. A driving device can be connected or built in at least one wheel. For example, the driving device can include a drive shaft, a speed reducer and a first motor. Alternatively, an in-wheel motor can be installed in the wheel as the first motor.

In addition, a steering device can be connected to the at least one wheel 51. For example, the steering device can include a steering shaft, the speed reducer and a second motor.

The first motor and the second motor can be electrically connected to the controller 40 of the smart pod 10, and when the first motor and the second motor are rotated forward and backward, the corresponding wheel 51 connected to the driving device and the steering device can be rotated to allow the smart pod 10 to be moved in a desired direction.

The smart pod 10 can implement autonomous driving by having a driving direction, a driving speed, a turning direction, a turning speed, a stopping position, a raising/lowering operation, an emergency stop or the like, controlled by the controller 40. Various sensors to control the autonomous driving can further be mounted on the smart pod 10.

In addition, the smart pod 10 can further include a robot arm 52 which can be coupled to the fastening protrusion on an upper surface thereof. The robot arm can be powered from the battery 33 of the smart pod, and its operation can be controlled by the controller 40 of the smart pod or the user's remote control.

The smart pod 10 illustrated in FIG. 6B can include a household appliance 53 together with the plurality of wheels 51 in order to improve convenience of life. The configuration and operation of the wheel can be the same as those described above with reference to FIG. 6A. However, the configuration and operation of the wheel may not be limited to the above example. The wheel can be detachably mounted to the smart pod, and can be operated to manually move the smart pod by manpower for example.

FIG. 6B illustrates an electric grill for cooking as an example of the household appliance 53. Such a household appliance can include a power terminal which can be coupled to the fastening protrusion 20 positioned on the upper surface of the smart pod 10, and thus receive power from the battery 33 of the smart pod.

The smart pod 10 illustrated in FIG. 6C can include a plurality of floats 54 as a moving means improving convenience of movement in the sea.

In addition, FIG. 6C illustrates the smart pod 10 including the hexagonal opening 16 and the door 17 opened and closed by being pivoted up and down about the hinge.

As described above, the smart pod 10 can further include the moving means such as the wheel 51 for its movement, and the smart pod itself can thus be utilized as a transport means to transport the cargo. In addition, the smart pod can be utilized as a power supply means of supplying power to another device such as the household appliance 53.

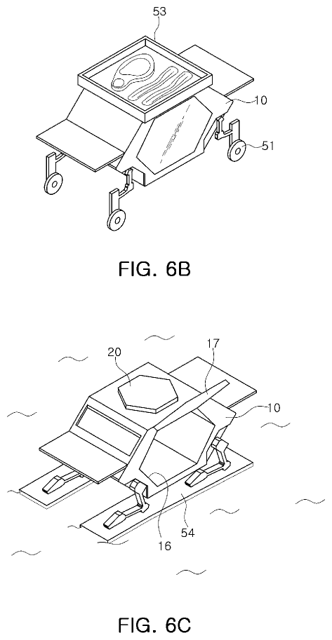

FIG. 7 is a cross-sectional view of another modified example of the smart pod.

The smart pods can have their sizes different from each other, thus include a plurality of first smart pods 10′ each having a smaller size, and a second smart pod 10″ having a larger size and capable of accommodating the plurality of first smart pods stacked on each other therein.

The plurality of first smart pods 10′ can respectively have a hexagonal cross-sectional area relatively much smaller than a hexagonal cross-sectional area of the second smart pod 10″.

In some examples, the upper inclined surfaces 14a′ and 14a″ and lower inclined surfaces 14b′ and 14b″ of the first and second smart pods can have the same inclination angles as each other, and the plurality of first the smart pods 10′can be stacked on each other more easily and stably when stacked in the second smart pod 10″.

Accordingly, the plurality of first smart pods 10′ in the second smart pod 10″ may not be shaken or moved, and maintain their posture and position. Due to this configuration, the cargo accommodated in the second smart pod can be transported more safely without damage.

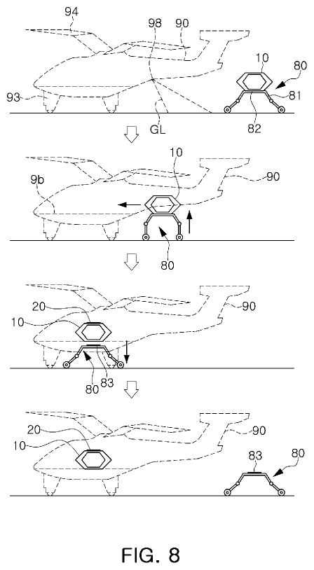

FIG. 8 is a view for explaining a method of loading the smart pod to a mobility; and FIG. 9 is an enlarged view specifically showing a portion of the loading method illustrated in FIG. 8.

The description describes a process of loading the smart pod 10 in which the cargo is placed into the cargo hold 91 of the mobility apparatus 90 from the transport robot 80 with reference to FIGS. 8 and 9.

The mobility apparatus 90 can be positioned on the ground or at cargo apron, and the transport robot 80 on which the smart pod 10 is loaded can be moved toward the mobility.

The transport robot 80 can perform the autonomous driving. In addition, the transport robot 80 can communicate with the control system, and thus can receive the position information of the assigned mobility apparatus 90 from the control system. In some cases, the transport robot 80 can transmit its own position information to the control system.

The transport robot 80 can be controlled in the driving direction, driving speed, turning direction, turning speed, stopping position, raising/lowering operation, emergency stop or the like by its controller. To control such an autonomous driving, the transport robot can be equipped with a battery and various sensors, which are not illustrated in the drawings.

The transport robot 80 can match the provided position information to a map stored in the controller, and then be moved to the vicinity of the mobility apparatus 90 by the controller controlling and operating a driver 81 in order to find the assigned mobility apparatus 90.

Such autonomous driving and navigation-related technologies are variously proposed in a transport robot field, and deviate from a gist of the present disclosure, and this specification omits detailed descriptions thereof.

However, in order to load the smart pod 10 into the mobility apparatus 90 or unload the smart pod 10 from the mobility apparatus 90, the transport robot 80 can further include a position detection unit controlling the smart pod to be put in an appropriate position by approaching very closely under the cargo hold 91 of the mobility.

The position detection unit can include the image sensor for example, and control movement of the transport robot together with the controller. Accordingly, the transport robot 80 can follow a guideline GL provided by the mobility apparatus 90, formed of light and having a predetermined shape and color, for example, and reach a desired position under the cargo hold 91 of the mobility apparatus 90.

An upper plate 82 of the transport robot 80 can have an overall flat shape, and the upper plate can serve as a loading area of the smart pod 10.

The transport robot 80 itself or the upper plate 82 of the transport robot can be raised or lowered, and thus raise or lower the smart pod 10 to an appropriate height when loading or unloading the smart pod.

A protrusion 83 (see FIG. 8) inserted into and coupled to the concave groove 15 in the lower surface 12 of the smart pod 10 can be positioned on the upper plate 82 of the transport robot 80. The protrusion can protrude upward from the upper plate and be shape-fitted with the concave groove of the smart pod.

Due to the flat-shaped upper plate 82 including the protrusion 83, the smart pod 10 can be stably loaded on the transport robot 80 and then moved.

In some implementations, a terminal unit electrically connected to the battery 33 can be positioned in the concave groove 15 positioned on the lower surface 12 of the smart pod 10. In addition, the protrusion 83 of the transport robot 80 can be made of the conductive material such as metal including copper, aluminum or steel for example, and electrically connected to a charger of the transport robot through a wire or the like.

Accordingly, when the protrusion 83 of the transport robot 80 is inserted into the concave groove 15 of the smart pod 10, the protrusion can be connected to the terminal unit of the concave groove to receive power from the battery 33 of the smart pod and to charge the transport robot.

For example, the mobility apparatus 90 can adopt cargo unmanned aerial system (CUAS) capable of vertical take-off and landing and including the cargo hold 91. The CUAS can be used for transporting a medium-sized cargo between cities at a high speed. However, the mobility is not limited to an example of the CUAS, and can employ various manned or unmanned mobility.

The mobility apparatus 90, to which the smart pod 10 can be applied, can include the cargo hold 91 for loading the cargo therein. The cargo hold 91 can accommodate the smart pod in which the cargo is placed, and have one surface, e.g. rear surface, capable of being opened to allow entry and exit of the smart pod.

The mobility apparatus 90 can include a plurality of wheels 93 positioned under its fuselage to support or move the mobility on the ground or at the cargo apron.

For example, when the mobility apparatus 90 is the air mobility such as the CUAS, the plurality of wheels 93 can function as landing gears.

Alternatively, when the mobility apparatus 90 is a land mobility such as an autonomous vehicle, the plurality of wheels 93 can be mounted on the mobility, and each wheel can have an independent drive motor to move the mobility on the ground.

In addition, when the mobility apparatus 90 is the air mobility such as a manned or unmanned aerial vehicle, the mobility can include a plurality of wings 94 or a plurality of rotors positioned on its fuselage. For example, the plurality of rotors can be provided for the vertical take-off and landing and horizontal flight of the fuselage.

A bottom plate 96 of the cargo hold 91 can include a cut groove 97 corresponding to the approach, entry or exit direction of the transport robot 80 and the smart pod 10. FIG. 9 illustrates a cut groove positioned in a length direction of the mobility apparatus 90. For example, the transport robot and the smart pod can approach the cargo hold from the rear of the cargo hold, and the smart pod can enter or exit the cargo hold through the rear surface of the cargo hold.

The cut groove 97 can be positioned to have one open end, e.g., open rear end of the bottom plate 96, and pass through the bottom plate. The cut groove can thus have an open cross section. A width of the cut groove can be larger than a width of the transport robot 80 and smaller than a length of the smart pod 10 in the length-direction axial line X.

An area of the bottom plate 96 in the cargo hold 91, other than the cut groove 97, can support the smart pod 10, and the above-described concave groove 95 (see FIG. 5) can be positioned in a ceiling surface of the cargo hold.

In addition, the mobility apparatus 90 can further include a guide 98 and the reaction member 29 to control the approach and alignment of the transport robot 80 and the smart pod 10.

The guide 98 can include a light irradiation unit, such as a laser light source, which is installed in an opening of the cargo hold and irradiates light periodically or continuously. The light irradiation unit can irradiate light having a predetermined color or pattern from the cargo hold to the ground or the cargo apron, thereby forming the guideline GL inducing the transport robot 80 to approach very closely to the cargo hold 91.

Accordingly, the transport robot 80 can be controlled to reach the desired position under the cargo hold 91 of the mobility apparatus 90 along the guide line GL formed of light by using the position detection unit.

As illustrated in examples of FIGS. 8 and 9, the transport robot 80 can be moved in the length direction of the mobility apparatus 90. The transport robot on which the smart pod 10 is loaded and moved close to the cargo hold 91 of the mobility can be inserted into and moved in the cut groove 97 in the length direction of the mobility in a state where the transport robot itself or the upper plate 82 of the transport robot is raised until the position detection sensor 28 of the smart pod detects the corresponding reaction member 29 of the mobility for example.

The reaction member 29 can be attached or mounted in the concave groove 95 of the cargo hold 91. The reaction member can be any of various members based on the shape and specification of the position detection sensor.

The transport robot 80 can be moved in the cut groove 97 until the position detection sensor 28 of the smart pod 10 detects the corresponding reaction member 29 of the mobility apparatus 90. In some implementations, the smart pod can be raised together with the transport robot or the upper plate 82 of the transport robot. In this state, there can thus be no interference with the cut groove of the mobility, and the transport robot can be moved smoothly in the cut groove.

The position detection sensor 28 can transmit the detection signal to the controller 40 of the smart pod 10, and the controller can transmit the detection signal to the controller of the transport robot 80 by using the communications module 42 and share the position information of the smart pod with respect to the concave groove 95 of the mobility apparatus 90. When the smart pod reaches its target position, the controller of the transport robot can stop the operation of the driver 81, thereby preventing the movement of the transport robot.

After the fastening protrusion 20 of the smart pod 10 and the concave groove 95 of the mobility apparatus 90 are aligned with each other, the controller 40 of the smart pod can operate the fastening protrusion so that the fastening member 22 protrudes from the upper surface 11 of the smart pod.

As illustrated in FIG. 5, the mobility apparatus 90 can selectively further include a chuck 99 gripping the fastening protrusion 20 of the smart pod 10 inserted into the concave groove 95 and the control system 92 controlling an operation of the chuck.

The chuck 99 can include, for example, a plurality of hydraulic cylinders such as a pneumatic cylinder, a plurality of electric actuators such as a solenoid actuator or the like, each equipped with an actuating rod. An extension direction of the plurality of actuating rods can be perpendicular to an insertion direction of the fastening protrusion 20.

The plurality of actuating rods included in the chuck 99 can be extended in the concave groove 95 of the mobility apparatus 90 in a plurality of directions, and thus grip the fastening protrusion 20 of the smart pod 10 inserted into the concave groove, thereby allowing the smart pod to be prevented from being moved in the cargo hold 91. When the plurality of actuating rods are retracted, the smart pod can be moved.

The control system 92 of the mobility apparatus 90 can communicate with the controller 40 of the smart pod 10. The controller of the smart pod can transmit the detection signal of the position detection sensor 28 and an operation signal of the fastening protrusion 20 to the control system of the mobility by using the communications module 42, and thus share the information on a state of the fastening protrusion inserted into the concave groove together with the position information of the smart pod with respect to the concave groove 95 of the mobility.

The control system 92 can control the operation of the chuck 99 positioned in the concave groove of the mobility apparatus 90 when the fastening protrusion 20 of the smart pod 10 and the concave groove 95 of the mobility apparatus 90 are aligned with each other and the fastening member 22 is then inserted into the concave groove.

The actuating rods of the chuck 99 can be extended in the concave groove 95 of the mobility apparatus 90, and the chuck can thus firmly grip at least both sides of the fastening member 22 of the smart pod 10 inserted into the concave groove of the mobility. Accordingly, the fastening protrusion 20 of the smart pod can be fixed in the concave groove of the mobility by the chuck.

Accordingly, the smart pod 10 can be constantly positioned and fixed in the cargo hold 91 of the mobility apparatus 90.

Next, the transport robot 80 or the upper plate 82 of the transport robot can be lowered, the protrusion 83 of the transport robot can thus come out of the concave groove 95 of the smart pod 10, and the smart pod can then be positioned and fixed on the bottom plate 96 in the cargo hold 91 of the mobility apparatus 90. In some examples, even when the fastening protrusion 20 positioned on the upper surface of the smart pod is slightly lowered, the fastening protrusion 20 can still be maintained inserted into the concave groove 95 of the mobility.

Finally, the transport robot 80 having a lower height can be moved away from the mobility apparatus 90. In this manner, the smart pod 10 accommodating the cargo can be automatically loaded into the cargo hold 91 of the mobility apparatus 90 from the transport robot 80 with no help of manpower.

A process of unloading the smart pod 10 from the mobility apparatus 90 can be performed in a reverse order of the above-described loading process. The description thus omits a detailed description of the unloading process.

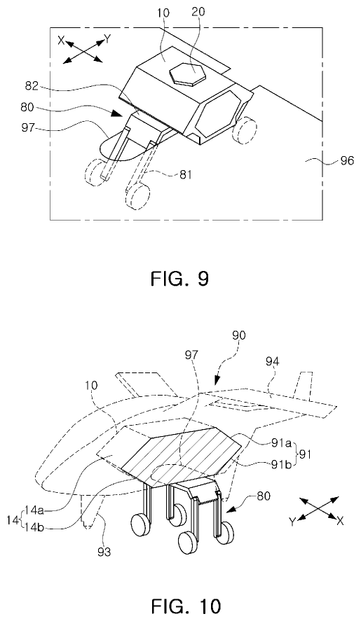

FIG. 10 is a view for explaining another example of the method of loading the smart pod to the mobility.

Another example in FIG. 10 illustrates differences only in the position of the cut groove 97 positioned in the bottom plate 96 of the cargo hold 91 and the direction in which the transport robot 80 enters and exits the cut groove. The other components are the same as those described with reference to FIGS. 8 and 9, the same reference numerals are thus given to the same components, and the detailed descriptions of their configuration and operation are omitted.

The description describes a process of loading the smart pod 10 in which the cargo is placed into the cargo hold 91 of the mobility apparatus 90 from the transport robot 80 with reference to FIG. 10.

The mobility apparatus 90 can be positioned on the ground or at the cargo apron, and the transport robot 80 loading the smart pod 10 thereon can be moved toward the mobility.

The transport robot 80 can perform the autonomous driving. In addition, the transport robot 80 itself or the upper plate 82 of the transport robot can be raised or lowered, and thus raise or lower the smart pod to an appropriate height when loading or unloading the smart pod.

For example, the mobility apparatus 90 can adopt the cargo unmanned aerial system (CUAS) capable of the vertical take-off and landing and including the cargo hold 91. The CUAS can be used for transporting the medium-sized cargo between cities at a high speed. However, the mobility is not limited to an example of the CUAS, and can employ various manned or unmanned mobility.

The mobility apparatus 90, to which the smart pod 10 can be applied, can include the cargo hold 91 for loading the cargo therein. The cargo hold can accommodate the smart pod in which the cargo is placed, and have one surface, e.g. at least one side surface, opened to allow the entry and exit of the smart pod.

The bottom plate 96 of the cargo hold 91 can include the cut groove 97 corresponding to the approach, entry or exit direction of the transport robot 80 and the smart pod 10. FIG. 10 illustrates the cut groove positioned in a width direction of the mobility apparatus 90. For example, the transport robot and the smart pod can approach the cargo hold from one side of the cargo hold, and the smart pod can enter or exit the cargo hold through one side surface of the cargo hold.

The cut groove 97 can be positioned to have one open end, e.g., open lateral end of the bottom plate 96, and pass through the bottom plate. The cut groove can thus have the open cross section. The width of the cut groove can be larger than the width of the transport robot 80 and smaller than the maximum length of the smart pod 10 in the width-direction axial line.

The area of the bottom plate 96 in the cargo hold 91, other than the cut groove 97, can support the smart pod 10, and the above-described concave groove 95 (see FIG. 5) can be positioned in the ceiling surface of the cargo hold.

In addition, an overall cross-sectional shape of the cargo hold 91 can be the hexagonal shape to correspond to the cross-sectional shape of the smart pod 10, and a space in the cargo hold and the smart pod can be shape-fitted with each other. For example, the upper inclined surface 14a and lower inclined surface 14b of the smart pod and the corresponding upper inclined surface 91a and lower inclined surface 91b of the cargo hold can have the same inclination angles as each other, and the smart pod can thus be positioned more stably when received in the cargo hold.

However, in order for the smart pod 10 to be easily received in the cargo hold 91, a hexagonal cross-sectional size of the cargo hold can be slightly larger than a hexagonal cross-sectional size of the smart pod.

The transport robot 80 can be moved to the vicinity of the target mobility apparatus 90 by using the autonomous driving and navigation technologies. Next, the transport robot can be controlled to reach the desired position under the cargo hold 91 of the mobility along the guide line GL formed of light by the guide 98 of the mobility by using the position detection unit.

The transport robot 80 on which the smart pod 10 is loaded and moved close to the cargo hold 91 of the mobility apparatus 90 can be inserted into and moved in the cut groove 97 in the width direction of the mobility in the state where the transport robot itself or the upper plate 82 of the transport robot is raised until the position detection sensor 28 of the smart pod detects the corresponding reaction member 29 of the mobility for example.

In some implementations, the smart pod 10 can be raised together with the transport robot or the upper plate 82 of the transport robot. In this state, there can thus be no interference with the cut groove 97 of the mobility apparatus 90, and the transport robot can be moved smoothly in the cut groove 97.

After the fastening protrusion 20 of the smart pod 10 and the concave groove 95 of the mobility apparatus 90 are aligned with each other, the controller 40 of the smart pod can operate the fastening protrusion 20 so that the fastening member 22 protrudes from the upper surface 11 of the smart pod.

The controller 40 of the smart pod 10 can transmit the detection signal of the position detection sensor 28 and the operation signal of the fastening protrusion 20 to the control system 92 of the mobility apparatus 90 by using the communications module 42, and thus share the information on the state of the fastening protrusion inserted into the concave groove together with the position information of the smart pod with respect to the concave groove 95 of the mobility.

The control system 92 can control the operation of the chuck 99 positioned in the concave groove of the mobility when the fastening protrusion 20 of the smart pod 10 and the concave groove 95 of the mobility apparatus 90 are aligned with each other and the fastening member 22 is then inserted into the concave groove.

The actuating rods of the chuck 99 can be extended in the concave groove 95 of the mobility apparatus 90, and the chuck can thus firmly grip at least both sides of the fastening member 22 of the smart pod 10 inserted into the concave groove of the mobility. Accordingly, the fastening protrusion 20 of the smart pod can be fixed in the concave groove of the mobility system by the chuck.

Accordingly, the smart pod 10 can be constantly positioned and fixed in the cargo hold 91 of the mobility apparatus 90.

Next, the transport robot 80 or the upper plate 82 of the transport robot can be lowered, the protrusion 83 of the transport robot can thus come out of the concave groove 95 of the smart pod 10, and the smart pod can then be positioned and fixed on the bottom plate 96 and the lower inclined surface in the cargo hold 91 of the mobility apparatus 90. In some examples, the fastening protrusion 20 positioned on the upper surface of the smart pod can still be maintained inserted into the concave groove 95 of the mobility.

Finally, the transport robot 80 having a lower height can be moved away from the mobility apparatus 90. In this manner, the smart pod 10 accommodating the cargo can be automatically loaded into the cargo hold 91 of the mobility apparatus 90 from the transport robot 80 with no help of manpower.

A process of unloading the smart pod 10 from the mobility apparatus 90 can be performed in a reverse order of the above-described loading process. The description thus omits a detailed description of the unloading process.

In some implementations, it can be possible to achieve the safe and convenient loading and unloading of the cargo as well as the fast and efficient transport of the cargo by receiving and modularizing the cargo.

In some implementations, it can be possible to use the minimum load space in the mobility for transporting cargo and a pod, and stably support the weight of the cargo in the corresponding space.

While exemplary implementations have been shown and described above, it will be apparent to those skilled in the art that modifications and variations could be made without departing from the scope of the present disclosure as defined by the appended claims.

What is claimed is:

1. A smart pod for transporting cargo, the smart pod comprising:
an upper surface;
a lower surface;
a pair of first sidewalls that connect the upper surface and the lower surface to each other, each of the pair of first sidewalls having a hexagonal shape; and
a fastening protrusion disposed at the upper surface and configured to retract from the upper surface.

2. The smart pod of claim 1, further comprising a pair of second sidewalls that connect the pair of first sidewalls to each other, each of the pair of second sidewalls including:
an upper inclined surface connected to the upper surface and inclined with respect to the upper surface, and
a lower inclined surface connected to the lower surface and inclined with respect to the lower surface.

3. The smart pod of claim 2, wherein at least one of the pair of first sidewalls defines an opening configured to receive and withdraw the cargo therethrough, and
wherein the smart pod further comprises a door disposed at the at least one of the pair of first sidewalls and configured to open and close the opening.

4. The smart pod of claim 3, wherein the door comprises a touchscreen configured to receive input of cargo information related to the cargo, the touchscreen being configured to display the cargo information or to cause the cargo information to be transmitted to an external server.

5. The smart pod of claim 1, wherein the lower surface defines a concave groove that is recessed from an outside of the smart pod to an inside of the smart pod and has a shape corresponding to the fastening protrusion, the concave groove being configured to receive and couple to a fastening protrusion of another smart pod.

6. The smart pod of claim 1, further comprising at least one of a solar power module, a global positioning system (GPS) module, a communications module, or a temperature control module.

7. The smart pod of claim 1, wherein the lower surface defines a concave groove that is recessed from an outside of the smart pod to an inside of the smart pod, and
wherein the smart pod further comprises a terminal that is disposed in the concave groove and electrically connected to a battery.

8. The smart pod of claim 1, wherein the upper surface defines a groove, and
wherein the fastening protrusion comprises:
a fastening member configured to retract into the groove of the upper surface; and
a driver disposed at the upper surface and configured to reciprocate the fastening member relative to the upper surface.

9. The smart pod of claim 8, wherein the fastening member is made of a conductive material and electrically connected to a battery.

10. The smart pod of claim 9, wherein the fastening member defines a rack gear on at least one surface thereof, and
wherein the driver comprises:
a motor configured to receive power from the battery, the motor comprising a rotation shaft; and
a pinion gear engaged with the rack gear and configured to rotate the rack gear based on rotation of the rotation shaft.

11. The smart pod of claim 8, further comprising:
a position detection sensor configured to detect a position of the fastening protrusion relative to a coupling object, the coupling object including (i) a concave groove configured to couple to the fastening protrusion and (ii) a reaction member that is disposed in the concave groove and configured to be detected by the position detection sensor.

12. The smart pod of claim 11, wherein the smart pod is configured to be moved by a transport apparatus, the transport apparatus being configured to be controlled by a transport controller,
wherein the smart pod further comprises a pod controller that is connected to the transport controller and configured to communicate with the transport controller to thereby restrict the transport apparatus from moving based on the position detection sensor detecting the reaction member.

13. The smart pod of claim 1, wherein the smart pod is one of a plurality of smart pods that are configured to be stacked on one another, the plurality of smart pods comprising a first smart pod having a first size and a second smart pod having a second size greater than the first size.

14. A mobility apparatus comprising a cargo hold configured to accommodate the smart pod according to claim 1, the cargo hold having a surface configured to be opened to receive or release the smart pod,
wherein the cargo hold comprises a bottom plate that defines a cut groove configured to receive and release the smart pod therethrough.

15. The mobility apparatus of claim 14, wherein the mobility apparatus is configured to receive the smart pod moved by a transport apparatus, and
wherein a width of the cut groove is greater than a width of the transport apparatus such that the cut groove allows the transport apparatus to be moved in the cut groove and to be raised from the cut groove based on the smart pod being moved by the transport apparatus.

16. The mobility apparatus of claim 15, wherein the bottom plate has an open end, and the cut groove is defined at the open end of the bottom plate.

17. The mobility apparatus of claim 15, wherein the bottom plate has an open end, and the cut groove is defined at the open end of the bottom plate, and
wherein an overall cross-sectional shape of the cargo hold is a hexagonal shape corresponding to a cross-sectional shape of the smart pod.

18. The mobility apparatus of claim 15, further comprising a guide configured to control approach and alignment between the transport apparatus and the smart pod, the guide comprising a light source configured to define a guide line.

19. The mobility apparatus of claim 15, wherein the smart pod further comprises a position detection sensor configured to detect a position of the cargo hold, and
wherein the cargo hold comprises:
a concave groove at a ceiling surface thereof, and
a reaction member disposed in the concave groove and configured to be detected by the position detection sensor.

20. The mobility apparatus of claim 19, further comprising:
a chuck configured to grip the fastening protrusion of the smart pod that is inserted into the concave groove; and
a control system configured to control operation of the chuck.
